(19) United States
(12) Patent Application Publication
(10) Pub. No.: US 2009/0142730 A1
(43) Pub. Date: Jun. 4, 2009

(54) Device for holding a dental instrument

(76) Inventor: Jacques Pernot, Vieilley (FR)

Correspondence Address: Cohne ,Gary M.,Esq;Strafford building Number Three, 125 Strafford avenue , Suite300, Wayne, PA, 19087, US

(21) Appl. No.: 11/658,302

(22) PCT Filed: Apr. 12, 2005
(86) PCT No.: PCT/FR05/00875

§ 371 Date: Nov. 6, 2008

(30) Foreign Application Priority Data
Jul. 27, 2004 (FR) 0408252

(51) Int. Cl. A61C 1/14

(52) U.S. Cl. 433/128

(57) ABSTRACT

The invention relates to a device for holding a dental instrument in the head of a contra-angle, an instrument of the type comprising, in its upper part which is inserted into the head of the contra-angle, a lateral flat for rotating it and an annular groove for axially retaining it, characterized in that the shank receiving the handle of the instrument, comprises a transverse cutback (7d), offset with respect to the longitudinal axis (7e) of the shank, made in the end of the shank and emerging in the bore (7b), the width (1) of the cutback being such that it allows the handle of the instrument to be engaged so that, on the one hand, the lateral flat of the handle is in contact with the wall (7f) of the cutback, closest to the longitudinal axis (7c), so as to ensure rotational coupling, and that, on the other hand, the shoulder of the flat of the handle abuts against the bottom (7c) of the longitudinal bore (7b) of the shank, in order to act as an axial stop in the direction of insertion.

Preferably, the device is in the form of a cartridge comprising, already assembled, a shank (7), a shank bearing (10), a resilient ring (8), a push-button (13) with a spring (12), and optionally a ball bearing (11).

The present invention relates to a device for fixing or holding dental instruments in the head of a contra-angle.

More specifically, the present invention relates to devices for fixing dental instruments, such as burs for example, in the head of a dental angle or contra-angle handpiece, which will be referred to as a “contra-angle” below.

Dental instruments such as burs consist of an active part and a handle, the handle being governed by a standard that defines the geometry of various types of handles. We are concerned with the fixing of handles having, in their upper part which is inserted into the head of the contra-angle, a groove for axially fixing the instrument in the head of the contra-angle, and a driving flat for rotating the instrument.

There are many devices, of varying complexity, for fixing and driving the instrument, which are suitable for various applications, and which meet different requirements depending on whether the purpose for which the contra-angle is to be used requires a greater or lesser force or torque.

A device is disclosed for example in French patent 2 570 269. Such a device has the advantage of being able to transmit high torques and of offering a very good resistance to removal of the instrument. The drawback is that it is complex in terms of its number of component parts and the complexity of the parts to be produced.

Another device is described by French patent 2 840 800. This device is based on a simple clamping system. It is certainly simple in terms of both the number of parts and the production of said parts, but it is not able to withstand high torques because the instrument is not driven positively by the flat provided for this purpose.

The aim of the invention is to propose a device for holding dental instruments in the head of a contra-angle, an instrument of the type comprising a flat for rotating it, and a groove for axially retaining it, which is simple to produce and can withstand or transmit high torques, and offers good resistance to axial wrenching of the instrument.

This aim is achieved by the invention which consists of a device for holding a dental instrument in the drive shank of the head of a contra-angle, an instrument of the type comprising, in its upper part which is inserted into the head of the contra-angle, a lateral flat for rotating it and an annular groove for axially retaining it.

The shank also comprises an annular groove positioned in such a way that it is substantially at the same level as the groove in the instrument when it is engaged in the use position, and that the face of the groove in the shank that is furthest away from the entry to the flat-bottomed bore is substantially at the same level as the face of the groove in the instrument that is remote from the active part of the instrument, axial retention in the direction of removal being thus ensured by a part which is engaged both in the groove in the instrument and in the groove in the shank.

The device also comprises a part for axially retaining the instrument which is in the form of a ring extended axially by resiliently flexible arms each comprising a projection oriented radially toward the axis of the ring, at least some of said arms being able to engage in the annular groove in the shank and in the annular groove in the handle of the instrument.

Preferably, the device is in the form of a cartridge which can be exchanged or dismantled easily if necessary for repair or cleaning. This cartridge comprises, already assembled, a shank, a shank bearing, a resilient ring, a push-button with a spring, and optionally a ball bearing.

The invention will be more clearly understood with the aid of the following description which is provided with reference to the following attached figures:

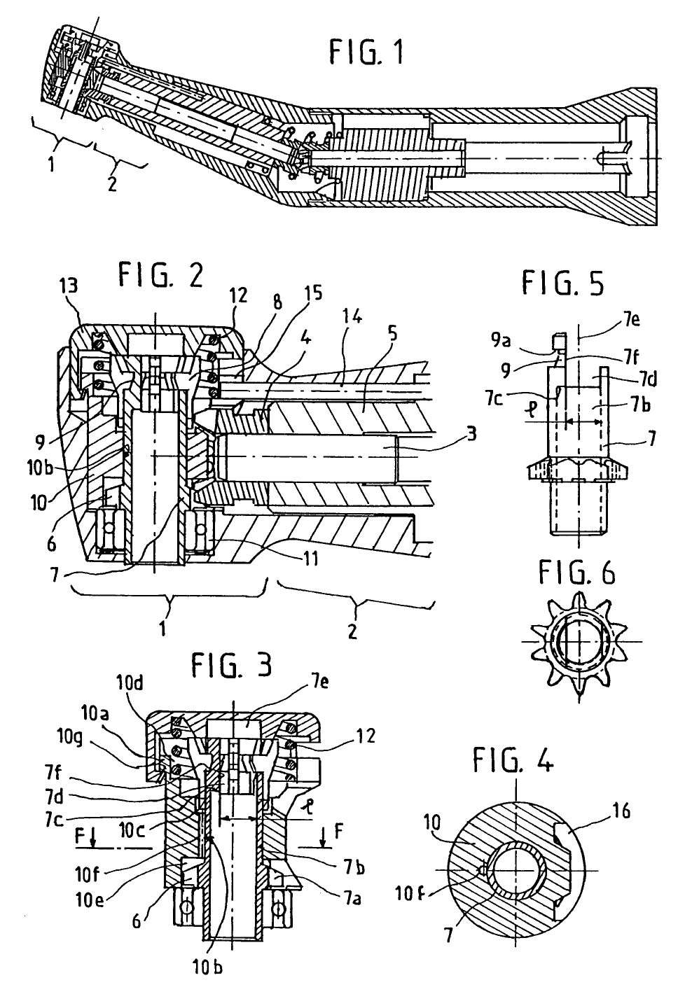

FIG. 1 shows, in longitudinal section, a contra-angle with the device according to the invention in a preferred, but nonlimiting, embodiment;

FIG. 2 shows a view in section of the head of the contra-angle of FIG. 1;

FIG. 3 shows the device according to the invention seen in longitudinal section and removed from the head of the contra-angle of FIG. 2;

FIG. 4 is a section along FF;

FIG. 5 is a front view of a shank according to a first embodiment used in the device of FIGS. 1 and 5;

FIG. 6 is a view from above of the shank of FIG. 5;

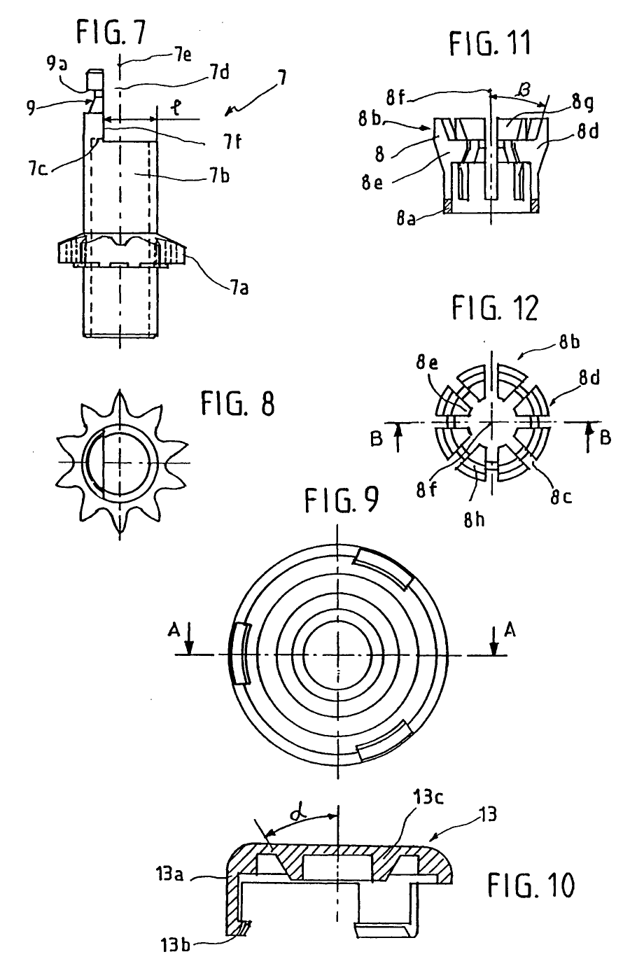

FIG. 7 is a front view of a shank according to a second embodiment;

FIG. 8 is a view from above of the shank of FIG. 7;

FIG. 9 shows an embodiment of the push-button belonging to the device according to the invention;

FIG. 10 is a section along AA of FIG. 9;

FIG. 11 shows a resilient ring of the device according to the invention in a nonlimiting embodiment and in a cross section along BB;

FIG. 12 is a view from above of FIG. 11.

FIG. 1 is provided to facilitate comprehension and show the general structure of a contra-angle to give a clearer picture of the positions of the various elements described below.

FIG. 2 is a view in section of a head (1) of a contra-angle and part of the neck (2) of said contra-angle. The neck (2) contains the movement transmission members, i.e. a shaft (3) having a pinion (4) at its end and mounted in a guide bearing (5). The pinion (4) meshes conventionally with corresponding pinion toothing (6) of the shank (7).

The shank (7) receives, at the top, a resilient locking ring (8) which is mounted externally on the shank simply by sliding said ring over the shank.

The resilient locking ring (8), as shown in detail in FIGS. 11 and 12, comprises a solid circular ring (8a) extended on one side by a skirt (8b) divided into angular sectors delimited by radial grooves (8c) distributed regularly around the skirt (for example at 45°). These sectors act as resilient arms (8d) and each comprises a projection (with a triangular cross section) (8e) oriented radially toward the axis (8f) of the ring and able to engage in an annular groove (9) in the shank (FIGS. 5 and 7). The shank is guided in rotation by a bearing (10) and optionally by a ball bearing fitted externally on the shank (7).

The bearing (10) of generally tubular shape (FIG. 3) ends at the top in a collar (10a) forming a shoulder (10g) with the body of the bearing.

On the inside, the bearing (10) comprises a central bore (10b) for guiding the shank, at the top a first housing (10c) for receiving the ends of the resilient arms (8d), a second cylindrical housing (10d) for receiving a resilient means such as a spring (12), and at the bottom a third housing (10e) for receiving the toothing (7a) of the shank, and longitudinally a groove (10f) for the passage of lubricant and/or cleaning fluids.

Laterally, the bearing (10) (FIG. 4) is machined at (16) to allow the toothing of the pinion (4) of the drive shaft to pass through (FIG. 2).

The bearing (10) acts as a support for the spring (12) which pushes a push-button (13).

The push-button (13) (FIGS. 9 and 10), of generally circular shape, is bordered peripherally and underneath by a collar (13a) which is itself bordered at least partially by a hook-shaped rim (13b) facing the central axis (13c) of the button.

The button (13) also comprises underneath a frustoconical central part (13c) which projects from the same side as the collar and has an acute angle (α) at the apex (for example 30°).

The outer conical surface of this central part (13c) is designed to engage in a frustoconical cavity (8g), provided internally in the opening in the skirt (8b) of the resilient ring (8), above the projections (8e), and created by all the faces (8h) of the arms (8d) (FIGS. 11 and 12). The slope (β) of said faces with respect to the central axis (8f) is for example 20°.

When it is inserted into the cavity (8g), the central part (13c) of the button parts the arms (8d), disengaging the projections (8e) from the annular groove (9) and thus freeing the instrument.

The push-button (13) is fixed not to the head (1) of the contra-angle as is often the case with contra-angles of known type, but to the bearing (10) via a snap-fastening device for example consisting on the one hand of the hooks (13b) of the button and engaging under the shoulder (10g) of the bearing.

The way in which the instrument is fixed in the shank (7) will now be described.

A handle of a dental instrument (not shown in the figures) comprises a lateral flat for driving and a transverse annular groove for axial retention, the handle of the instrument being received in the rotating part or shank (7).

The shank according to the invention comprises a longitudinal bore (7b) with a flat bottom (7c) receiving the handle of the instrument, and comprises a transverse cutback (7d), offset with respect to the longitudinal axis (7e) of the shank, made in the end of the shank and emerging in the bore (7b).

Two variant embodiments are shown by way of example in FIGS. 5 to 8.

In all cases, the width (1) of the cutback is such that it allows the handle of the instrument to be engaged in such a way that, on the one hand, the lateral flat of the handle is in contact with the wall (7f) of the cutback, closest to the longitudinal axis (7e), so as to ensure rotational coupling, and that, on the other hand, the shoulder of the flat of the handle abuts against the bottom (7c) of the longitudinal bore (7b) of the shank, in order to act as an axial stop in the direction of insertion.

Another feature of the shank is that it has an annular groove (9) positioned in such a way that it is substantially at the same level as the groove in the instrument when it is engaged in the use position, and that the face (9a) of the groove (9) in the shank that is furthest away from the entry to the flat-bottomed bore is substantially at the same level as the face of the groove in the instrument that is remote from the active part of the instrument. Axial retention in the direction of removal may thus be ensured by a part which is engaged both in the groove in the instrument and in the groove in the shank. According to the embodiment shown in the figures, this part consists of the projections (8e) of the resilient arms (8d) of the ring (8).

Owing to the combination of features which has just been described regarding the fixing of the instrument on the shank and the locking and unlocking using the ring-button assembly, the applicant had the idea of a new drive concept in the form of a cartridge as shown in FIGS. 3 and 4 which can be exchanged or dismantled easily if necessary for repair or cleaning.

The cartridge of FIGS. 3 and 4 comprises, already assembled as explained above, a shank (7), a shank bearing (10), a resilient ring (8), a push-button (13) with a spring (12), and optionally a ball bearing (11).

The cartridge is rotationally immobilized, to ensure correct transmission of movement, by a finger (14) integral with the bearing (5) of the neck (2), which interacts with a complementary shape (15) made in the bearing (10) of the shank. Therefore, assembling the cartridge and the head together is very simple. Specifically, with a view to assembly, the cartridge is engaged in the head which at this point does not have the bearing (5) or, therefore, the finger (14) (this operation is performed without any special tool), and then the bearing (5) is engaged in position, thus putting in place the finger (14) for rotationally immobilizing the cartridge.

In the same way, modules at each level of assembly of the cartridge may be envisaged, for example:
a shank engaged in a bearing and in the resilient ring,
a spring/push-button module,
a ball bearing module.

1. A device for holding a dental instrument in the head of a contra-angle, an instrument of the type comprising, in its upper part which is inserted into the head of the contra-angle, a lateral flat for rotating it and an annular groove for axially retaining it, the device comprising a rotating part called a shank which receives the upper part or handle of the instrument and is rotated by movement transmission members contained in a handle of the contra-angle, namely mainly a shaft (3) having at its end a pinion (4) which meshes conventionally with corresponding pinion toothing (6) of the shank (7), characterized in that the shank comprises a longitudinal bore (7b) with a flat bottom (7c) receiving the handle of the instrument, and comprises a transverse cutback (7d), offset with respect to the longitudinal axis (7e) of the shank, made in the end of the shank and emerging in the bore (7b), the width (1) of the cutback being such that it allows the handle of the instrument to be engaged so that, on the one hand, the lateral flat of the handle is in contact with the wall (7f) of the cutback, closest to the longitudinal axis (7c), so as to ensure rotational coupling, and that, on the other hand, the shoulder of the flat of the handle abuts against the bottom (7c) of the longitudinal bore (7b) of the shank, in order to act as an axial stop in the direction of insertion.

2. The device as claimed in claim 1, characterized in that the shank also comprises an annular groove (9) positioned in such a way that it is substantially at the same level as the groove in the instrument when it is engaged in the use position, and that the face (9a) of the groove (9) in the shank that is furthest away from the entry to the flat-bottomed bore is substantially at the same level as the face of the groove in the instrument that is remote from the active part of the instrument, axial retention in the direction of removal may thus be ensured by a part which is engaged both in the groove in the instrument and in the groove in the shank.

3. The device as claimed in claim 2, characterized in that the device comprises a part for axially retaining the instrument which is in the form of a ring extended axially by resiliently flexible arms each comprising a projection (8e) oriented radially toward the axis (8f) of the ring, at least some of said arms being able to engage in the annular groove (9) in the shank and in the annular groove in the handle of the instrument.

4. The device as claimed in claim 3, characterized in that the axial retention ring comprises a solid circular ring (8a) extended on one side by a skirt (8b) divided into angular sectors delimited by radial grooves (8c) distributed regularly around the skirt, these sectors acting as resilient arms (8d) and each comprising a projection (with a triangular cross section) (8e) oriented radially toward the axis (8f) of the ring and able to engage in an annular groove (9) in the shank.

5. The device as claimed in either of claims 3 and 4, characterized in that it also comprises a bearing (10) which ends at the top in a collar (10a) forming a shoulder (10b) with the body of the bearing, used for snap-fastening a push-button (13).

6. The device as claimed in one of claims 3 to 5, characterized in that it also comprises a push-button (13) of generally circular shape which is bordered peripherally and underneath by a collar (13a) comprising underneath a frustoconical central part (13c) which projects from the same side as the collar, designed to engage in a frustoconical cavity (8g), provided internally in the opening in the skirt (8b) of the resilient ring (8), above the projections (8e).

7. The device as claimed in claim 5, characterized in that the collar of the push-button (13) is itself bordered at least partially by a hook-shaped rim (13b) facing the central axis (13c) of the button.

8. The device as claimed in one of claims 1 to 7, characterized in that it is in the form of a cartridge which can be exchanged or dismantled easily if necessary for repair or cleaning.

9. The device as claimed in claim 8, characterized in that the cartridge comprises, already assembled, a shank (7), a shank bearing (10), a resilient ring (8), a push-button (13) with a spring (12), and optionally a ball bearing (11).

10. The device as claimed in either of claims 8 and 9, characterized in that the cartridge is immobilized in rotation, to ensure correct transmission of movement, by a finger (14) integral with the bearing (5) of the neck (2), which interacts with a complementary shape (15) made in the bearing (10) of the shank.
